(19) United States
(12) Patent Application Publication
(10) Pub. No.: US 2010/0096440 A1
(43) Pub. Date: Apr. 22, 2010

(54) Folder with Exposure Notch and Other Source Features

(75) Inventors: Michael B. Lasky, Atlanta, GA (US); Christine M. Plantan, Wayzata, MN (US)

Correspondence Address: Altera Law Group, LLC, 220 S 6 St Suite 1700, Minneapolis, MN, 55402, US

(73) Assignee: Smead Manufacturing Company

(21) Appl. No.: 12/644,169

(22) Filed: Dec. 22, 2009

Related U.S. Application Data
(63) Continuation of application No. 11/650,719, filed on Jan. 8, 2007.
(60) Provisional application No. 60/758,496, filed on Jan. 12, 2006.

(51) Int. Cl. B65D 27/00; B31B 1/14

(52) U.S. Cl. 229/67.1; 493/340

(57) ABSTRACT

A file folder system is disclosed which allows the manufacturer to display indicia information (such as source indicia, such as a trademark) to the folder without detracting from the utility of the folder itself. Several embodiments are disclosed include a notch in one folder panel which creates a window in the other panel where the indicia in imprinted. In another embodiment, one panel is punched through to reveal portions of the other panel. These apertures are formed in the pattern of the desired indicia, so that the user can determine if there are contents in the folder and simultaneously, the indicia is permanently displayed without obstructing the use of the folder.

### FIELD OF THE INVENTION

The present invention is in the field of office requisites and a method of improving product source identification.

### BACKGROUND OF THE INVENTION

File folders and other paper storage systems are of great utility in an office setting. The most common storage system, the common manila folder, for example are widespread and relatively inexpensive, and have convenient tabs suitable for writing. Because they are such a commodity product, it is difficult to distinguish one maker's product from another. It would be useful to gain brand loyalty without sacrificing utility. Utility would be impeded/interfered with by placing an indicia, usually a trademark on a portion folder where a surface might be obscured by indicia. Thus marking on an exterior or tab surface of the folder will decrease its utility.

The typical solution to increasing brand (source) recognition, has been to simply apply the name of the manufacturer on the outside faces of the product, but this may be objectionable because it limits the utility of the product by the user. Often the outer faces are used by the customer to identify the contents.

The preferred solution would be to find a way to indicate the source of the maker, without damaging the utility, and indeed, to enhance the utility by integrating source recognition feature with a utilitarian function and to do so without adding cost.

### BRIEF SUMMARY OF THE INVENTION

There are several aspects to the invention and reference should be had to the detailed description and the claims. For the reader's convenience a summary of some of salient features appears below.

The present invention is directed to a folder system which uses the inside panel(s) for imprintation of source relating indicia and provides a notch like aperture on the front-most panel, in the top edge to expose a portion of the source indicating indicia.

In another embodiment, where the folder includes an end tab, at least a portion of the exposed end tab is covered with source indicating indicia, preferably in light color, so that it may be written over with a marker and the markings still be readable.

In the preferred embodiment, the entire inside of the folder is imprinted with source indicating indicia, perhaps in a pattern.

In a further embodiment, a system and method of displaying contents of the folder and simultaneously applying an indicia to a file is disclosed using a plurality of holes punched in one face of the folder which allows visibility into the folder. The holes are punched in a pattern which forms the desired indicia.

This summary is just exemplary. Reference should be had to the detailed description for further inventive concepts and to the claims.

### BRIEF DESCRIPTION OF THE SEVERAL VIEWS OF THE DRAWINGS

FIG. 1 illustrates a plan view of one embodiment;

FIG. 2 illustrates a plan view of another embodiment with an indicia imprint; and

FIG. 3 illustrates a perspective view of an alternative embodiment.

FIG. 4 illustrates a perspective view of an alternative embodiment with a side tab; and

FIG. 5 illustrates another embodiment employing apertures in one of the panels.

### DETAILED DESCRIPTION OF THE INVENTION

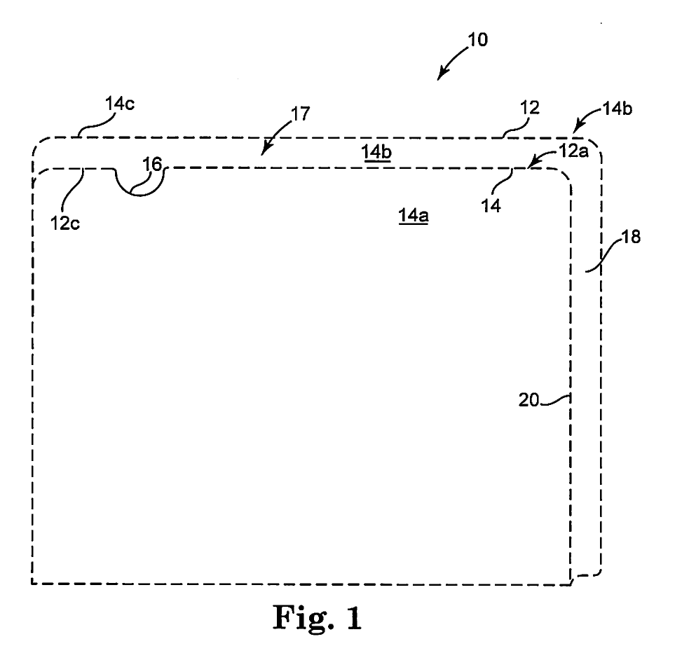

A file folder 10 is illustrated in FIG. 1. Note that this invention is not limited to file folders, but one is shown as an example. The invention may be applied to a broad range of office products, particularly where they have overlapping faces, including file jackets, binders, note pads, etc.

Folder 10 has a back panel or sheet 12, a front panel or sheet 14, both of which have inner 12a, 12b, and 14a, 14b and outer surfaces. The inner surface is defined by opposing faces from panels 12 and 14. In this embodiment the panels are joined foldably together to form the folder features, but in other embodiments, they may form pockets or other useful structures.

Each panel 12, 14 has a top edge 12c, 14c and in the case of panel 12, an exposure notch 16 is cut into the top edge. The notch in this case is circular, approximately semicircular. Other shapes are possible so long as they permit viewing a portion of the surface 14b therethrough. When the front and back panels are adjacent each other (with or without other papers therebetween), the notch exposes a portion of the inside surface 14b which may be referred to as the “window area”. The optimal size, as will be explained below is where the cut out (notch) is just sufficiently large to display one occurrence of a repeating source indicia, or other indicia.

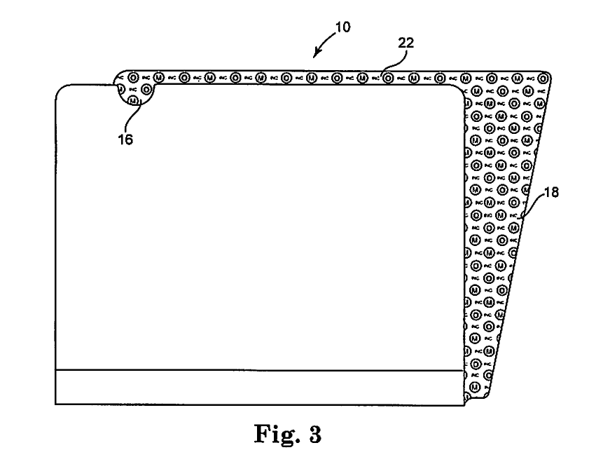

In this illustration, the folder has both a top tab 17 and a side-tab 18, which is an extension of the back sheet which extends beyond the side edge 20 of the front sheet 12 to allow the file to be viewed from the side edge when on an open shelf. It will be understood that both top and side tabs may be made, or one of each or neither (see FIG. 3). One embodiment (not shown) is a notch 16 placed on the side where the side tab (18) is located but with or without a side tab.

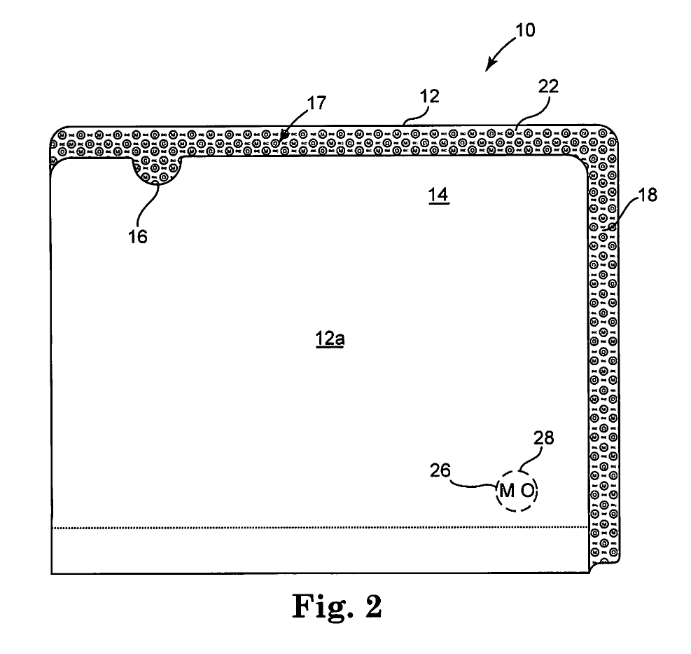

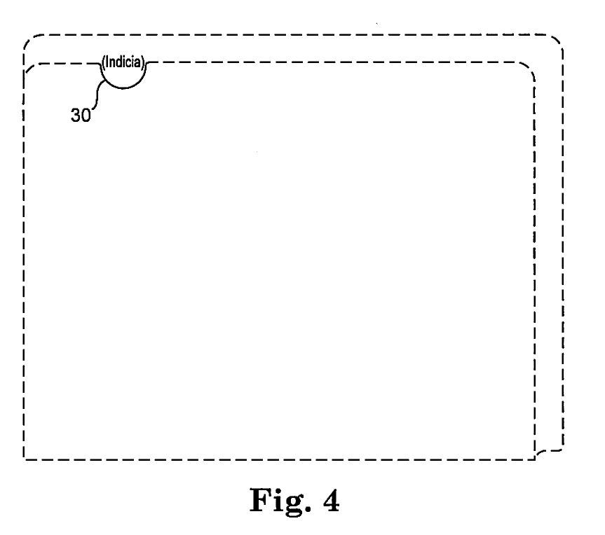

If the notch is located on a panel orthogonal to the tab (side or top) then the tab may be labeled or indicia written upon without obscuring the trademark indicia of the notch. Thus, it is possible to maintain the indicia without detracting from the functionality of the folder. In FIG. 2, with a top tab and a notch on the same side, the same would be true and the trademark indicia could be restricted to the shadow/window region of the back panel (and not cover the tab area as shown). This is illustrated in FIG. 4 at 30 where only the window area includes an indicia.

FIG. 2 illustrates that this system can be used to advantage with the inner surfaces 14b (and perhaps 12b) flooded with a repeat of source indicia such as the MO™ trademark (a trademark of The Smead Manufacturing Company) use for illustration. The imprint 22 of the source indicia (or some other indicia such as a warning or other differentiator) is preferably made in a light shade or pastel color or half tone. The best choice is a background imprint of such low density that it will be possible to over write with marker and still read the marking over the indicia. This allows the indicia to be used, but does not inhibit the function of the tab space on the top, edge or in the notch.

In the preferred embodiment the indicia repeat 22 is aligned with the notch 16 so that it exactly registered in the notch window and the indicia is not “cut off”. Multiple repeats can be shown if they are small enough.

FIG. 3 is similar to FIG. 2 except that the folder only has a side tab 18 and no top tab. Notch 16 is present as well as the indicia behind it.

FIG. 4 is an embodiment where the tab area above the notch is left blank and only the window/shadow area on the back panel includes an indicia 30. This formulation insures that the tab area above the notch will be fully unobstructed. In short, by notching the front panel anywhere (top or side), indicia can be applied to the window created by the notch and the utility of the folder is intact. The notch can be any shape or depth not just as shown.

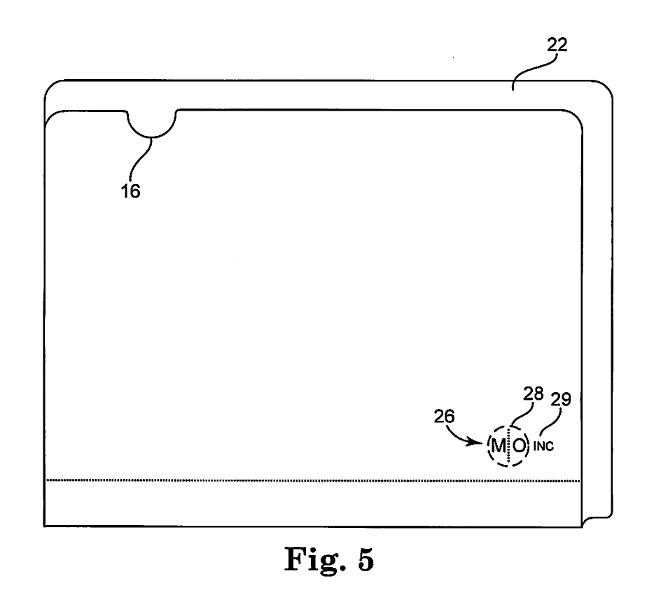

Another embodiment, shown in FIG. 5 shows another way to indicate source indicia without compromising the utility of the folder system. It is to perforate, such as by a plurality of holes 28 into the front and/or back sheet in the form of the indicia 26 itself. The trademark MO™ ( a trademark of Smead Manufacturing Company to this invention) is used merely for illustration. In effect, the indicia itself is a series of closely spaced small holes creating the indicia pattern and may be place anywhere on the sheets. The holes are punched or drilled into the surfaces and if drilled in both sheets, will allow light through. Even if drilled/punched into only one sheet, the apertures will allow the user to know if there are papers in the folder at a glance, yet the function of the folder in unimpeded. In this embodiment, notch 16 is shown, but not required. The hole spacing to form the indicia pattern can be any size so long as the documents intended for the folder will not fall out. Thus the utility of the folder is not impeded by reasonable sized punches or cut outs. The holes are preferably large enough that a user can view the interior of the folder to determine if there are indeed any contents. In the case of the exemplary indicia, the circle 28 must have holes sufficiently spaced apart that the center of the circle does not fall out. The words “inc”, 29 are likewise made with a series of holes or apertures. It is possible imprint the indicia with ink before punching to accentuate the patter and provide a visual que as to how the letters are formed. It is also possible to flood the interior side 22 of the back panel with a contrasting color (such as black or grey) to insure that the indicia will be prominent and as an indicator to know that there are documents in the file (usually white).

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1.-8. (canceled)

9. A folder system for displaying a source indicator on a folder without interfering with the function of the folder comprising;
a folder having front and back panels each having inner and outer faces, the inner faces being opposing,
a punch pattern formed in the front sheet at a one edge, which, when said front and back panels are adjacent, a portion of the back panel, defined by punched pattern, is visible through the pattern.

10. The system of claim 9 wherein said punched pattern is a pattern of holes arrange as a source indicator.

11. The system of claim 9 wherein the inside surface of the back panel is darker than the front surface of the front panel, at least in the region of the punched pattern, so that the pattern is made more visible by contrasting colors.

12. A method of indicating whether there are contents in a file folder while simultaneously applying a source indicator to the folder's surface, comprising, the folder having first and second panels each having inner and outer faces, the inner faces being opposing, comprising;
forming a pattern in the first panel by creating apertures therethrough which reveal the inner surface of the second panel which, when said front and back panels are adjacent, allowing a portion of the second panel to be visible through the apertures.

13. The method of claim 12 wherein said the first panel is first imprinted at least a portion of the indicia before creating said apertures, so that the indicia is defined by both imprinting and apertures.

14. The method of claim 12 wherein said pattern is formed by a series of adjacent holes punched into the first panel.

15. The method of claim 12 further including darkening the inside surface of the second panel relative to outside surface of the first panel, so that the pattern defined by the apertures is accentuated by relative contrast between first and second panels.

16. A method of making an indicator folder comprising the steps of:
folding a planar material into two parts, creating a front panel and a rear panel, the fold being such that the rear panel extends beyond the front panel along two adjacent edges;
flooding the inside face of the back panel with a colorant darker in shade than the outside face of the front panel;
cutting an indicator notch in said front panel to expose a portion of the inside face of the rear panel.
